(19) United States
(12) Patent Application Publication
(10) Pub. No.: US 2024/0426620 A1
(43) Pub. Date: Dec. 26, 2024

(54) INFORMATION PROCESSING METHOD

(71) Applicant: Panasonic Automotive Systems Co., Ltd., Kanagawa (JP)

(72) Inventor: Satoshi FUKUMOTO, Tokyo To (JP)

(73) Assignee: Panasonic Automotive Systems Co., Ltd., Kanagawa (JP)

(21) Appl. No.: 18/594,626

(22) Filed: Mar. 4, 2024

(30) Foreign Application Priority Data
Jun. 23, 2023 (JP) 2023-102929

(51) Int. Cl. G01C 21/34; B60W 30/14; B60W 50/14; G01C 21/36; H04L 43/0882; H04W 4/024; H04W 24/08; H04W 48/16; H04W 88/06

(52) U.S. Cl. CPC G01C 21/3461; B60W 30/146; B60W 50/14; G01C 21/3415; G01C 21/3605; H04L 43/0882; H04W 4/024; H04W 24/08; H04W 48/16; H04W 88/06

(57) ABSTRACT

An information processing method includes acquiring a communication band map indicating a communication band of wireless communication with one of base stations. The method includes estimating a position of a vehicle performing wireless communication with the one of base stations. The method includes estimating a band prediction value indicating a communication band predicted for wireless communication to be performed with the one of base stations. The band prediction value is estimated on the basis of the position of the vehicle and the communication band map. The method includes controlling a vehicle behavior of the vehicle according to the band prediction value.

### CROSS-REFERENCE TO RELATED APPLICATIONS

This application is based upon and claims the benefit of priority from Japanese Patent Application No. 2023-102929, filed on Jun. 23, 2023, the entire contents of which are incorporated herein by reference.

### FIELD

The present disclosure relates generally to an information processing method.

### BACKGROUND

Conventionally, there are known techniques for providing driving assistance such as vehicle control and in-vehicle entertainment such as moving image reproduction in a moving vehicle by using wireless communication with a wireless base station.

For example, a patent literature JP 2021-135100 A discloses a technique for correcting a driving route of a vehicle so as to obtain predetermined radio field intensity during content download using a radio field intensity map in a case where communication cannot be performed at a timing desired by a user.

However, radio wave resources are finite, and for example, a communication band per wireless base station is shared by the whole vehicles including a user's vehicle. Therefore, a communication band that can be used by the user's vehicle greatly changes with the number of communication with vehicles per wireless base station, namely, a congestion state of communication. In addition, radio waves (millimeter waves) in a high frequency band such as 5G and 6G have high directivity, and the communication band available to the user's vehicle greatly changes depending on the area. Moreover, the communication band greatly changes depending on date, time, and weather.

For these reasons, even when the radio field intensity can be sufficiently obtained, a predetermined communication band cannot be obtained, and for example, in a vehicle equipped with a driving function accompanied by wireless communication, there is a possibility that safety at the time of driving is affected.

### SUMMARY

An information processing method according to the present disclosure includes acquiring a communication band map indicating a communication band of wireless communication with one of base stations. The method includes estimating a position of a vehicle performing wireless communication with the one of base stations. The method includes estimating a band prediction value indicating a communication band predicted for wireless communication to be performed with the one of base stations. The band prediction value is estimated on the basis of the position of the vehicle and the communication band map. The method includes controlling a vehicle behavior of the vehicle according to the band prediction value.

### BRIEF DESCRIPTION OF THE DRAWINGS

FIG. 1 is a diagram schematically illustrating an example of a vehicle in which a vehicle behavior control device according to an embodiment is installed;

FIG. 2 is a diagram illustrating an example of a configuration of an information processing system including the vehicle behavior control device according to the embodiment;

FIG. 3 is a diagram illustrating an example of a hardware configuration of each device of the information processing system according to the embodiment;

FIG. 4 is a diagram illustrating an example of a functional configuration of the vehicle behavior control device according to the embodiment;

FIG. 5 is a diagram illustrating an example of a functional configuration of a data processing device according to the embodiment;

FIG. 6 is a flowchart illustrating an example of a procedure of vehicle behavior control processing before driving executed by the information processing system according to the embodiment;

FIG. 7 is a diagram illustrating an example of a display screen displayed in the processing of FIG. 6;

FIG. 8 is a flowchart illustrating an example of a procedure of vehicle behavior control processing during driving executed by the information processing system according to the embodiment;

FIG. 9 is a diagram illustrating an example of a display screen displayed in the processing of FIG. 8;

FIG. 10 is a diagram illustrating another example of the display screen displayed in the processing of FIG. 8;

FIG. 11 is a diagram for explaining an example of control of a vehicle behavior in the processing of FIG. 8; and

FIG. 12 is a flowchart illustrating an example of a procedure of communication band map generation processing executed by the information processing system according to the embodiment.

### DETAILED DESCRIPTION

Hereinafter, embodiments of an information processing device, a vehicle, an information processing system, an information processing method, a program, and a storage medium according to the present disclosure will be described with reference to the drawings.

In the description of the present disclosure, components having the same or substantially the same functions as those described above with respect to the previously described drawings are denoted by the same reference numerals, and the description thereof may be appropriately omitted. In addition, even in the case of representing the same or substantially the same part, the dimensions and ratios may be represented differently from each other depending on the drawings. Moreover, for example, from the viewpoint of ensuring visibility of the drawings, in the description of each drawing, main components are denoted by reference numerals, and even components having the same or substantially the same functions as those described above in the previous drawings may not be denoted by reference numerals.

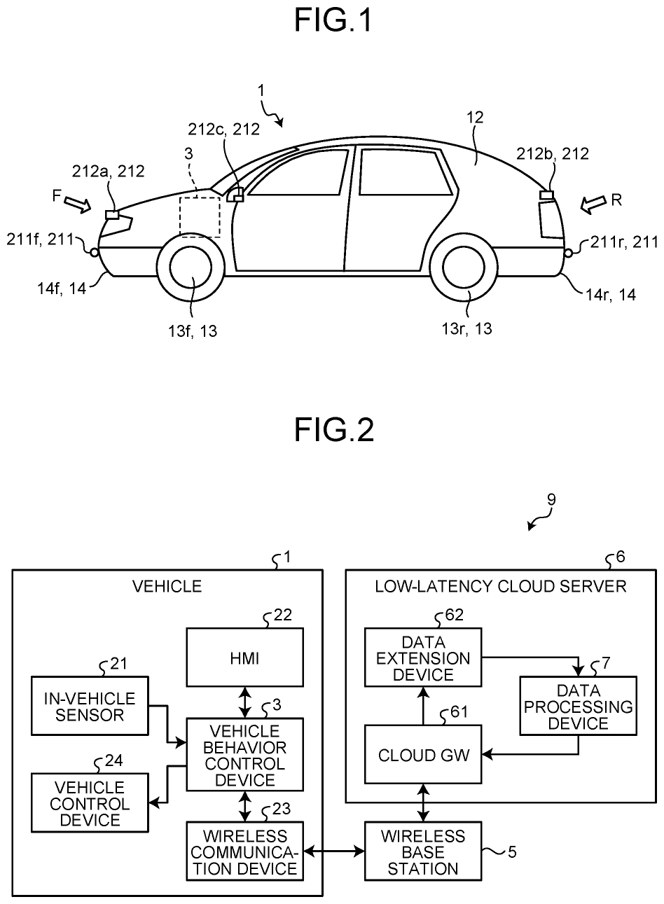

FIG. 1 is a diagram schematically illustrating an example of a vehicle 1 in which a vehicle behavior control device 3 according to an embodiment is installed. As illustrated in FIG. 1, the vehicle 1 includes a vehicle body 12 and two pairs of wheels 13 disposed in a predetermined direction on the vehicle body 12. The two pairs of wheels 13 include a pair of front tires 13f and a pair of rear tires 13r.

The front tire 13f according to the embodiment is an example of a first wheel. The rear tire 13r according to the embodiment is an example of a second wheel. Although FIG. 1 illustrates the vehicle 1 with the four wheels 13, the present disclosure is not limited thereto. The vehicle 1 may have at least one front tire 13f and at least one rear tire 13r. The number of wheels 13 of the vehicle 1 may be two, three, or five or more.

A direction of at least one wheel (steering wheel) of the wheels 13 of the vehicle 1 electrically or mechanically interlocks with, for example, a rotation angle of a steering wheel disposed in front of a driver's seat 130, namely, a steering angle. The vehicle 1 can turn right or left by steering. The steering wheel may be the rear tire 13r or both the front tire 13f and the rear tire 13r.

The vehicle body 12 is supported by the wheels 13. The vehicle 1 includes a driving machine (not illustrated), and is movable by driving at least one wheel (driving wheel) of the wheels 13 of the vehicle 1 by power of the driving machine. As the driving machine, an optional driving machine such as an engine using gasoline, hydrogen, or the like as a fuel, a motor using electric power from a battery, or a combination of an engine and a motor can be applied. In this case, a predetermined direction in which the two pairs of wheels 13 are arranged is a driving direction of the vehicle 1. The vehicle 1 can move forward or backward by switching gears (not illustrated) or the like.

The vehicle body 12 has a front end part F which is an end part near the front tire 13f and a rear end part R which is an end part near the rear tire 13r. The vehicle body 12 has a substantially rectangular shape in top view, and four corners of the substantially rectangular shape may be referred to as end parts.

A pair of bumpers 14 is provided near a lower end of the vehicle body 12 at the front and rear end parts F and R of the vehicle body 12. A front bumper 14f of the pair of bumpers 14 covers the entire front surface and part of the side surface in the vicinity of the lower end part of the vehicle body 12. A rear bumper 14r of the pair of bumpers 14 covers the entire rear surface and part of the side surface in the vicinity of the lower end part of the vehicle body 12.

FIG. 2 is a diagram illustrating an example of a configuration of an information processing system 9 including the vehicle behavior control device 3 according to the embodiment. As illustrated in FIG. 2, the information processing system 9 includes a wireless base station 5 and a low-latency cloud server 6 in addition to the vehicle 1 in which the vehicle behavior control device 3 is installed.

The information processing system 9 can be constructed as a server-client type system including the low-latency cloud server 6 and the vehicle behavior control device 3 as a client that performs wireless communication with the low-latency cloud server 6 via the wireless base station 5.

The information processing system 9 is configured to be capable of executing vehicle behavior control processing and communication band map generation processing according to the embodiment. Here, at least one of the vehicle behavior control processing and the communication band map generation processing according to the embodiment is an example of information processing implemented by the information processing method. In addition, at least one of the vehicle behavior control device 3 and the low-latency cloud server 6 according to the embodiment is an example of an information processing device.

Each of the vehicle behavior control processing and the communication band map generation processing according to the embodiment includes processing in the client executed by the vehicle behavior control device 3 and processing in the server executed by the low-latency cloud server 6. The vehicle behavior control processing according to the embodiment includes processing executed as pre-processing at a time point before a driving route is determined, such as at the time of setting the driving route, or at a time point before the start of driving, and processing executed as real-time processing at a time point after the start of driving such as at the time point of driving, for example. The communication band map generation processing according to the embodiment may be executed prior to the vehicle behavior control processing or may be executed using information obtained in the vehicle behavior control process.

As illustrated in FIG. 2, the vehicle 1 is equipped with an in-vehicle sensor 21, an HMI 22, a wireless communication device 23, a vehicle control device 24, and a vehicle behavior control device 3. Each of the in-vehicle sensor 21, the HMI 22, the wireless communication device 23, and the vehicle control device 24 is connected to the vehicle behavior control device 3 via an in-vehicle network including a controller area network (CAN), Ethernet (registered trademark), or the like.

Although FIG. 2 illustrates a case where each of the in-vehicle sensor 21, the HMI 22, the wireless communication device 23, and the vehicle control device 24 is not included in the vehicle behavior control device 3, the present disclosure is not limited thereto. Some or all of them may be included in the vehicle behavior control device 3.

For example, as illustrated in FIG. 1, the in-vehicle sensor 21 includes a sonar (sound navigation and ranging) 211 and an all-around camera 212.

The sonar 211 is provided at a predetermined end part of the vehicle body 12, for example, and transmits and receives a sound wave such as an ultrasonic wave. The sonar 211 includes wave transmitting/receiving units 211f and 211r. For example, at least one wave transmitting/receiving unit 211f is disposed on the front bumper 14f, and at least one wave transmitting/receiving unit 211r is disposed on the rear bumper 14r. Moreover, the number and/or positions of the wave transmitting/receiving units 211f and 211r are not limited to the example illustrated in FIG. 1, and can be changed as appropriate. For example, the vehicle 1 may include wave transmitting/receiving units 211f and 211r on the left and right sides.

The sonar 211 detects an obstacle around the vehicle 1 on the basis of the transmission/reception result of the sound wave. In addition, the sonar 211 measures a distance between an obstacle around the vehicle 1 and the vehicle 1 on the basis of the transmission/reception result of the sound wave.

In the present embodiment, the sonar 211 using a sound wave such as an ultrasonic wave is exemplified, but the present disclosure is not limited thereto. For example, the vehicle 1 may include, instead of the sonar 211 or in addition to the sonar 211, a radar (RADAR: Radio Detection and Ranging) that transmits and receives radio waves or a LiDAR (Light Detection And Ranging) that transmits and receives laser light.

The all-around camera 212 is provided in the vehicle 1 so as to be able to image the surroundings of the vehicle 1. In one example, the vehicle 1 includes, as the all-around camera 212, a front camera 212a that images the front, a rear camera 212b that images the rear, a left-side camera 212c that images the left side, and a right-side camera (not illustrated) that images the right side.

The all-around camera 212 captures an image around the vehicle 1. The all-around camera 212 is, for example, a camera that captures an image based on visible light and/or infrared light. Note that the image captured by the all-around camera 212 may be a moving image or a still image.

Note that the positions and/or number of the all-around cameras 212 is not limited to the example illustrated in FIG. 1 and can be changed as appropriate. For example, the vehicle 1 may include two cameras, the front camera 212a and the rear camera 212b. Alternatively, the vehicle 1 may further include another camera in addition to the above-described example. For example, some or all of the all-around cameras 212 may be provided on a vehicle interior space (inside the vehicle) of the vehicle 1. The all-around camera 212 may be a camera built on the vehicle 1, a camera of a drive recorder retrofitted to the vehicle 1, or the like.

The in-vehicle sensor 21 includes various sensors (not illustrated). In one example, the in-vehicle sensor 21 includes a steering angle sensor that outputs a signal corresponding to an operation amount of the steering wheel by a driver, namely, a steering angle. In one example, the in-vehicle sensor 21 includes a wheel speed sensor that outputs a signal corresponding to the rotation speed and the rotation direction of the wheel 13. In one example, the in-vehicle sensor 21 includes a brake sensor that detects an operation amount of a brake pedal by the driver. In one example, the in-vehicle sensor 21 includes an accelerator sensor that detects an operation amount of an accelerator pedal by the driver. In one example, the in-vehicle sensor 21 includes an acceleration sensor that outputs a signal corresponding to acceleration applied to the vehicle 1. In one example, the in-vehicle sensor 21 includes a gyro sensor that outputs a signal corresponding to an angular velocity applied to the vehicle 1. The acceleration sensor and the gyro sensor may be provided in three axes, for example, and configured as an inertial measurement unit (IMU). In one example, the in-vehicle sensor 21 includes a global navigation satellite system (GNSS) sensor that outputs position information of the vehicle 1, such as a global positioning system (GPS) sensor. Note that the GNSS sensor includes a GNSS antenna that receives radio waves from a satellite, and a GNSS circuit that obtains position information on the basis of radio waves from at least two satellites received by the GNSS antenna.

The HMI 22 is an interface for outputting various types of information such as route guidance, notification, and warning to the driver of the vehicle 1. The HMI 22 is an interface for receiving input of various types of information by the driver of the vehicle 1. The HMI 22 according to the embodiment is an example of a display unit and an input unit. The HMI 22 is able to output various types of information so as to be recognizable by the driver of the vehicle 1 and receive various operations of the driver of the vehicle 1. For example, the HMI 22 is provided around the driver's seat of the vehicle 1, but may be provided in another part around the driver's seat such as a rear seat.

In one example, the HMI 22 includes a display provided on a dashboard or a console of the vehicle 1 and configured to be able to output a video. The display is, for example, a liquid crystal display (LCD) or an organic electro luminescence (EL) display. Note that the display may be configured as a touch panel display. Moreover, the display may be part of a car navigation device installed on the vehicle 1. Moreover, the display may be a projection-type display device such as a Head Up Display (HUD) that projects a video (virtual image) in front of the driver, for example, in a display area provided on a windshield or a dashboard (console). Note that the HMI 22 may include another output device such as a speaker configured to be capable of outputting a notification sound, a warning sound, or a voice.

In one example, the HMI 22 includes a touch panel of a touch panel display as an input device. The HMI 22 may include other input devices such as buttons, dials, switches, and microphones. These input devices are disposed, for example, on a dashboard, an instrument panel, a steering wheel, a console, or the like of the vehicle 1.

As the HMI 22, an operation terminal, such as a tablet terminal, a smartphone, a remote controller, or an electronic key, which can transmit or receive a signal to or from the outside of the vehicle 1, may be used.

The wireless communication device 23 transmits and receives a wireless signal for transmitting information between the vehicle 1 and the wireless base station 5. The wireless communication device 23 includes an antenna (not illustrated), and is configured to be able to transmit and receive wireless signals between the vehicle 1 and the wireless base station 5 via the antenna. The transmission and reception of the wireless signals are performed by an optional cellular V2X system such as mobile communication systems of each generation according to regulations of IMT 2020 such as 3G, LTE, 4G, and 5G or specifications of 3GPP (registered trademark), or a next-generation mobile communication system such as Beyond 5G (6G).

Note that the communication method may be another communication method such as an IEEE-compliant DSRC method or a vehicle-to-cellular-network (V2N) method.

The vehicle control device 24 includes a steering control device and a drive/brake control device.

The steering control device controls steering of the vehicle 1. For example, the steering control device deflects the wheels 13 in a direction according to a control signal corresponding to an operation amount of the steering wheel by the driver or a control signal from the vehicle behavior control device 3 or a data processing device 7. Note that the steering control device may include a steering actuator (not illustrated) that changes the rotation angle of the steering wheel in accordance with a control signal from the vehicle behavior control device 3 or the data processing device 7.

The drive/brake control device controls acceleration/deceleration of the vehicle 1. The drive/brake control device includes, for example, a brake actuator (not illustrated) and an engine controller (not illustrated). The brake actuator operates a brake, changes a shift (gear ratio), or controls an output of a driving machine such as an engine or a motor on the basis of a detection result of a brake sensor (not illustrated) that detects an operation amount of a brake pedal by a driver or a control signal from the vehicle behavior control device 3 or the data processing device 7, thereby braking the vehicle 1 or decelerating the vehicle 1. The accelerator controller accelerates the vehicle 1 by controlling the output of the driving machine such as the engine or the motor on the basis of the detection result of the accelerator sensor (not illustrated) that detects the operation amount of the accelerator pedal by the driver or the control signal from the vehicle behavior control device 3 or the data processing device 7.

The vehicle behavior control device 3 is an example of the information processing device that can be installed on the vehicle 1. The vehicle behavior control device 3 is configured to be capable of executing the vehicle behavior control processing and the communication band map generation processing according to the embodiment in cooperation with the data processing device 7. Specifically, the vehicle behavior control device 3 is configured to execute processing in the client of each of the vehicle behavior control processing and the communication band map generation processing. The vehicle behavior control device 3 is implemented by, for example, an electronic control unit (ECU) provided inside the vehicle 1 or an on board unit (OBU). Alternatively, the vehicle behavior control device 3 may be an external computer installed near a dashboard of the vehicle 1. Note that the vehicle behavior control device 3 may also serve as a car navigation device or the like.

The wireless base station 5 relays communication between each vehicle 1 and the low-latency cloud server 6. Specifically, the wireless base station 5 transmits and receives the wireless signal for transmitting information to and from each vehicle 1 in the covered area. The wireless base station 5 is connected to the low-latency cloud server 6 via the wired or wireless electric communication line, and transmits and receives information to and from the low-latency cloud server 6. The wireless base station 5 according to the embodiment is an example of a base station serving as a communication destination among base stations.

Note that, in FIG. 2, an optional one wireless base station 5 is exemplified as the communication destination base station to which the vehicle 1 transmits and receives information, but the information processing system 9 includes two or more wireless base stations 5. Those wireless base stations 5 are installed such that an area covered by a wireless base station 5 overlaps with an area covered by an adjacent wireless base station 5. The area covered by the wireless base station 5 refers to a range of positions of various information processing terminals such as the vehicle 1 and a smartphone capable of transmitting and receiving information. As the wireless base station 5, road-side equipment such as a roadside machine may be used.

The low-latency cloud server 6 is at least one server device that provides cloud computing. In one example, the low-latency cloud server 6 is at least one edge server device that provides edge computing.

The low-latency cloud server 6 is an example of an information processing device that executes processing using data from plural vehicles 1. The data processing device 7 is configured to be capable of executing the vehicle behavior control processing and the communication band map generation processing according to the embodiment in cooperation with the vehicle behavior control device 3. Specifically, the data processing device 7 is configured to execute the processing in the server of each of the vehicle behavior control processing and the communication band map generation processing. The processing in the server may be processing related to each function of an advanced driving assistant system (ADAS) such as collision damage reduction brake (AEB) processing and sudden unintended acceleration prevention processing, high-load AI processing, vehicle position estimation processing of estimating the position of the vehicle 1, and route generation processing of generating a driving route used for self-driving, automatic parking, or navigation by the vehicle 1.

The low-latency cloud server 6 has a characteristic of low latency. The low latency means that the latency of communication viewed from the vehicle 1 is small or the latency time is short. In one example, the low-latency cloud server 6 is disposed at or near the wireless base station 5 that relays a wireless signal from the vehicle 1. Note that the low-latency cloud server 6 is not limited to the wireless base station 5 that relays wireless signals from the vehicle 1. The low-latency cloud server 6 may be provided in an exchange station that bundles a plurality of wireless base stations 5, another wireless base station 5 using the exchange station as a hub, another exchange station or another wireless base station 5 in the same area connected to the exchange station via a backbone network or the like, or in the vicinity thereof.

The “near A” may be, for example, a range in which latency viewed from the vehicle for processing involving communication via A does not exceed a predetermined threshold value, or a range in which a physical distance from A does not exceed a predetermined threshold value. In addition, the same area may refer to, for example, the same city or the same prefecture.

As illustrated in FIG. 2, the low-latency cloud server 6 includes a cloud gateway (GW) 61, a data extension device 62, and a data processing device 7.

The cloud GW 61 connects communication from the vehicle 1 via the wireless base station 5 to the low-latency cloud server 6. In one example, the cloud GW 61 converts a communication protocol and a data format with respect to data received from the vehicle 1 via the wireless base station 5 or data transmitted from the data processing device 7 to the vehicle 1 via the wireless base station 5.

The data extension device 62 extends the data from the vehicle 1 converted by the cloud GW 61 to the data processing device 7. Specifically, the data extension device 62 distributes data from the vehicle 1 to the data processing device 7 that executes processing among the data processing devices 7 of the low-latency cloud server 6.

The data processing device 7 is an example of an information processing device that executes processing using data from the vehicles 1. The data processing device 7 is configured to be capable of executing the vehicle behavior control processing and the communication band map generation processing according to the embodiment in cooperation with the vehicle behavior control device 3. Specifically, the data processing device 7 is configured to execute the processing in the server of each of the vehicle behavior control processing and the communication band map generation processing. In addition, the data processing device 7 outputs the processed data to the cloud GW 61.

Although FIG. 2 illustrates one data processing device 7 that executes processing using data from the vehicle 1, the information processing system 9 may include two or more data processing devices 7. In one example, the data processing devices 7 are provided with multiple processors, and are configured to be able to execute the processing in the server according to the embodiment by any of the multiple processors, namely, at least one processor. Alternatively, the processing in the server may be configured to be executable by at least one of the data processing devices 7.

Note that the data extension device 62 is not an essential configuration, and may not be provided in the low-latency cloud server 6. Alternatively, the data extension device 62 may be implemented as one function of the data processing device 7.

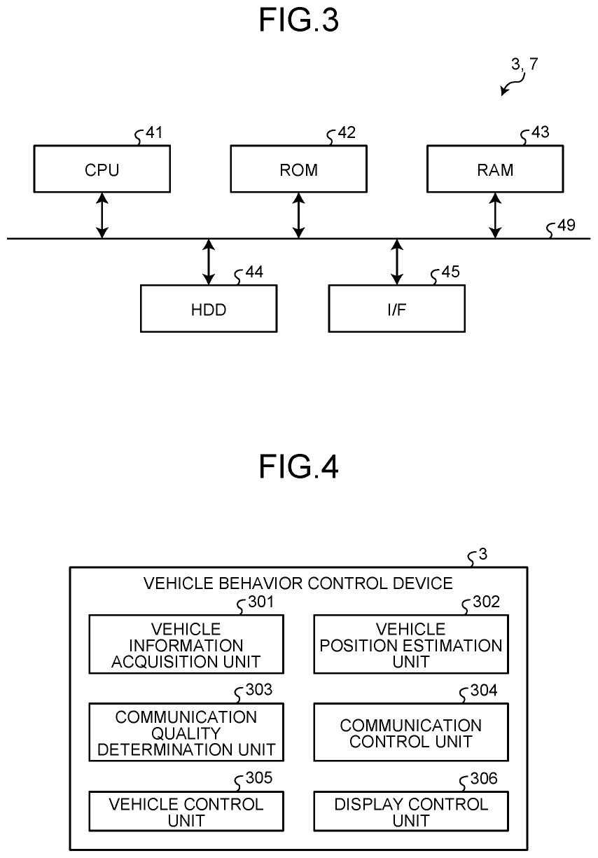

FIG. 3 is a diagram illustrating an example of a hardware configuration of each device of the information processing system 9 according to the embodiment.

As illustrated in FIG. 3, each of the devices (for example, the vehicle behavior control device 3 and the data processing device 7) of the information processing system 9 includes a central processing unit (CPU) 41, a read only memory (ROM) 42, a random access memory (RAM) 43, a hard disk drive (HDD) 44, and an interface (I/F) 45. The CPU 41, the ROM 42, the RAM 43, the HDD 44, and the I/F (interface) 45 are mutually connected by a bus 49 or the like, and have a hardware configuration using a normal computer.

The CPU 41 is an arithmetic device that entirely controls each device of the information processing system 9. The CPU 41 loads a program stored in the ROM 42 or the HDD 44 into the RAM 43 and executes the program, thereby implementing each processing described later.

Note that the CPU 41 according to the embodiment is an example of a processor in each device of the information processing system 9. As the processor, another processor may be provided instead of the CPU 41 or in addition to the CPU 41. As other processors, various processors such as a graphics processing unit (GPU) and a digital signal processor (DSP), a dedicated arithmetic circuit implemented by an application specific integrated circuit (ASIC) and a field programmable gate array (FPGA), and the like can be used as appropriate.

The ROM 42 stores programs, parameters, and the like that implement various processing by the CPU 41. The RAM 43 is a main storage device of each device of the information processing system 9, and temporarily stores data used for various processing by the CPU 41. The HDD 44 stores various data, programs, and the like used in each device of the information processing system 9. Note that, instead of the HDD 44 or in addition to the HDD 44, various storage medium and storage devices such as a solid state drive (SSD) and a flash memory can be used as appropriate.

When the ROM 42, the RAM 43, and the HDD 44 are not distinguished from one another, they may be simply referred to as “internal memory”.

In one example, the internal memory of the vehicle behavior control device 3a stores a communication band map generated in advance, a communication band map generated in the vehicle behavior control device 3, and/or a communication band map corrected in the vehicle behavior control device 3. Note that a correction coefficient or the like may be stored in the internal memory in place of the corrected communication band map.

The I/F 45 is an interface for transmitting and receiving data.

In one example, the I/F 45 of the vehicle behavior control device 3 may receive data from other devices provided on the vehicle 1, for example, the in-vehicle sensor 21, the HMI 22, and the wireless communication device 23. The I/F 45 of the vehicle behavior control device 3 may transmit data to other devices provided on the vehicle 1, for example, the HMI 22, the wireless communication device 23, and the vehicle control device 24.

Note that the I/F 45 of the vehicle behavior control device 3 may transmit and receive information to and from another ECU installed on the vehicle 1 via the in-vehicle network of the vehicle 1, or may communicate with an information processing device outside the vehicle 1 via a network such as the Internet.

In one example, the I/F 45 of the vehicle behavior control device 3 may acquire information about the state of the vehicle 1 such as steering, vehicle speed, tire pulse, angular velocity including yaw rate, acceleration, position information, shift information, and a vehicle log from ECUs via the in-vehicle network.

FIG. 4 is a diagram illustrating an example of a functional configuration of the vehicle behavior control device 3 according to the embodiment. The vehicle behavior control device 3 executes a program loaded in the RAM 43 by the CPU 41 to implement functions as a vehicle information acquisition unit 301, a vehicle position estimation unit 302, a communication quality determination unit 303, a communication control unit 304, a vehicle control unit 305, and a display control unit 306.

The vehicle information acquisition unit 301 acquires sensor data from the in-vehicle sensor 21 via, for example, the I/F 45. In one example, the vehicle information acquisition unit 301 acquires various sensor data from the sonar 211 as the in-vehicle sensor 21, the all-around camera 212, RADAR, LiDAR, and IMU.

The vehicle information acquisition unit 301 acquires information about the state of the vehicle 1 via, for example, the I/F 45. In one example, the vehicle information acquisition unit 301 acquires information about the state of the vehicle 1 such as the steering, vehicle speed, tire pulse, angular velocity including yaw rate, acceleration, position information, shift information, and vehicle log by communication with other ECUs via the in-vehicle network.

The vehicle position estimation unit 302 performs the vehicle position estimation processing of estimating the position of the vehicle 1 wirelessly communicating with the wireless base station 5. In one example, the vehicle position estimation unit 302 acquires position coordinates of the current position of the vehicle 1 including the movement amount and the movement direction of the vehicle 1 using information acquired by the vehicle information acquisition unit 301 from, for example, the in-vehicle sensor 21. Note that the vehicle position estimation unit 302 may perform the vehicle position estimation processing by acquiring position coordinates of the current position of the vehicle 1 by the GNSS sensor of the in-vehicle sensor 21.

The communication quality determination unit 303 determines the communication quality and controls the vehicle behavior according to the communication quality. In a case where low communication quality is predicted, the communication quality determination unit 303 limits or changes the vehicle behavior. The communication quality refers to quality of a communication band in wireless communication with the wireless base station 5 or quality of a communication band that can be secured or used by the vehicle 1 in wireless communication with the wireless base station 5. When controlling the vehicle behavior, the communication quality determination unit 303 may limit the vehicle behavior by the HMI 22 or may guide the user about the limited vehicle behavior.

In one example, the communication quality determination unit 303 acquires a communication band map indicating a communication band of wireless communication with the wireless base station 5 from the internal memory or the low-latency cloud server 6.

In one example, the communication quality determination unit 303 receives a user input such as a search condition and a destination for searching for a route candidate input via the HMI 22. The route candidate is a candidate of a driving route for guiding the vehicle 1 to the destination to be presented to the user. In addition, the search condition is a condition for specifying priority in search of route candidates such as “time priority”, “distance priority”, “bandwidth priority”, and “toll priority”. The time priority, distance priority, bandwidth priority, and toll priority are conditions for instructing to search for a route with a short time, a route with a short distance, a route in which a communication band is easily obtained, and a route with a low toll as route candidates, respectively.

In one example, the communication quality determination unit 303 refers to the communication band map and acquires information about the communication band of the current position, the route candidate, or the driving route. The information about the communication band of the current position, the route candidate, or the driving route includes a band prediction value indicating an estimated communication band of the current position, the route candidate, or the driving route. For example, the communication quality determination unit 303 acquires a band actual measurement value indicating a current communication band in the current wireless communication with the wireless base station 5, and corrects the communication band map using the band actual measurement value and the current position. Then, the communication quality determination unit 303 estimates a band prediction value indicating a communication band predicted on the route candidate on the basis of the corrected communication band map.

In one example, the communication quality determination unit 303 determines in advance whether low communication quality is predicted in the set driving route. For example, the communication quality determination unit 303 determines in advance whether a minimum communication band is secured over the entire set driving route. In other words, the communication quality determination unit 303 determines in advance whether the band prediction value is equal to or less than a predetermined threshold value in at least part of the set driving route. For example, in a case where the minimum communication band is not secured over the entire set driving route, or in a case where it is predicted in advance that the band prediction value is equal to or less than a predetermined threshold value in at least part of the set driving route, the communication quality determination unit 303 determines that low communication quality is predicted in the set driving route. Note that the minimum communication band is, for example, a threshold value of a communication band determined in advance and stored in the internal memory of the vehicle behavior control device 3 or the like. The minimum communication band is set on the basis of, for example, a communication band of wireless communication used for executing the self-driving function of the vehicle 1, but can be optionally set.

In one example, the communication quality determination unit 303 determines whether low communication quality is predicted at the current position or on the course during driving. For example, the communication quality determination unit 303 determines whether the band prediction value is equal to or less than a predetermined threshold value at the current position or the position on the course during driving. For example, in a case where the band prediction value is equal to or less than a predetermined threshold value at the current position or the position on the course, the communication quality determination unit 303 determines that low communication quality is predicted at the current position or the course.

In one example, the controlling of the vehicle behavior includes: stop (invalidation) of the self-driving function, change of the communication mode of the wireless communication with the wireless base station 5, limitation of the vehicle speed of the vehicle 1, and/or notification to the user when low communication quality is predicted in advance in the set driving route. The communication quality determination unit 303 according to the embodiment determines in advance whether the self-driving function can be executed over the entire set driving route.

In one example, the controlling of the vehicle behavior includes: a change of a communication mode of wireless communication with the wireless base station 5, the limitation of the vehicle speed of the vehicle 1, and/or a notification to the user when low communication quality is predicted during driving at the current position or on the course.

The change in the communication mode includes a change in a communication method, a compression rate of data to be transmitted and received, resolution of image data to be transmitted and received, a frame rate of video data to be transmitted and received, and/or a sampling rate of sensor data to be transmitted and received in wireless communication. Note that such a change in the communication mode is not limited to selection of transmission/reception data in wireless communication, and may control data acquisition itself by the in-vehicle sensor 21 or the like.

Moreover, the limitation of the vehicle speed of the vehicle 1 means that the speed of the vehicle 1 is limited to a speed equal to or lower than the vehicle speed at which the functions related to driving and safety among the functions of the vehicle 1 can be executed by wireless communication using the band prediction value. For example, the limitation of the vehicle speed in the self-driving is based on a predetermined value or a calculation formula as the vehicle speed at which the self-driving can be safely executed under the wireless communication using the band prediction value.

The notification to the user includes degenerating the function of the vehicle 1 such as stopping the self-driving function, changing the communication mode, or limiting the vehicle speed, or guiding the content thereof. The notification to the user regarding the stop of the self-driving function includes a guidance sign of manual driving until a predetermined communication band is obtained.

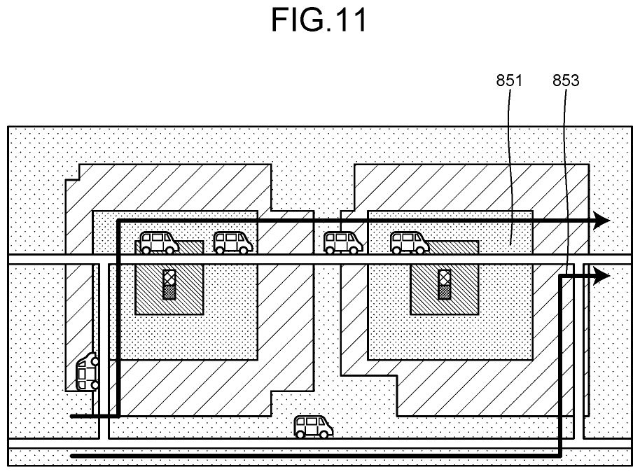

In one example, the controlling of the vehicle behavior includes changing at least one of the driving route and the vehicle speed of the vehicle 1 so as to limit the number of vehicles in an area where congestion of the communication band is predicted on the basis of the band prediction value, or guidance of the change (see FIG. 11).

In one example, the controlling of the vehicle behavior includes changing the driving zone (driving lane) in which the vehicle 1 travels to a driving zone that corresponds to a higher band prediction value or a driving zone that is closer to an area corresponding to a higher band prediction value, or guidance of the change.

In one example, the controlling of the vehicle behavior includes, regarding wireless communication with the wireless base station 5, limiting a communication band related to other functions such as a vehicle log function, a vehicle entertainment function (in-vehicle entertainment function), and an in-vehicle infotainment (IVI) function, with priority given to a predetermined function related to safety and security such as a driving assistance function (for example, an ADAS function) such as an self-driving function and a home parking function, and a driver monitor function, or the guidance of the limitation.

The communication control unit 304 controls wireless communication by the wireless communication device 23 with the wireless base station 5.

In one example, the communication control unit 304 changes the communication mode according to the controlling of the vehicle behavior by the communication quality determination unit 303.

In one example, the communication control unit 304 transmits and receives data related to each function including processing involving communication of the vehicle 1 to and from the data processing device 7 by the wireless communication via the wireless base station 5.

In one example, the communication control unit 304 transmits search information of a route including a destination and a search condition of the user and a current position of the vehicle 1 to the data processing device 7 by the wireless communication via the wireless base station 5. The communication control unit 304 receives, from the data processing device 7, a search result of a route candidate corresponding to the search information of a route from the vehicle 1.

The vehicle control unit 305 controls at least one of steering, braking, and acceleration/deceleration of the vehicle 1.

In one example, the vehicle control unit 305 controls at least one of steering, braking, and acceleration/deceleration of the vehicle 1 according to a user operation or a processing result of the data processing device 7 according to the controlling of the vehicle behavior by the communication quality determination unit 303.

The display control unit 306 controls display by the HMI 22.

In one example, the display control unit 306 displays the display screen including the information about the communication band from the HMI 22 according to the controlling of the vehicle behavior by the communication quality determination unit 303. The information about the communication band includes the information about the band prediction value, the communication band map, and/or the guidance on the controlling of the vehicle behavior.

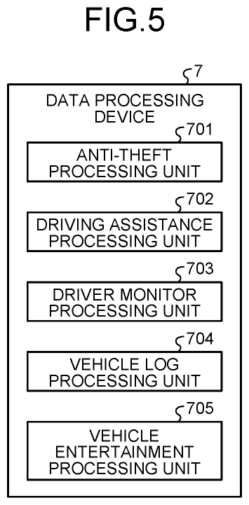

FIG. 5 is a diagram illustrating an example of a functional configuration of the data processing device 7 according to the embodiment. The data processing device 7 implements functions as an anti-theft processing unit 701, a driving assistance processing unit 702, a driver monitor processing unit 703, a vehicle log processing unit 704, and a vehicle entertainment processing unit 705 by causing the CPU 41 to execute a program loaded in the RAM 43.

The anti-theft processing unit 701 executes the processing in the server related to the anti-theft function of the vehicle 1. The anti-theft function is a function including processing involving wireless communication of the vehicle 1. The anti-theft function may be an example of a function related to safety and security of the vehicle 1.

The driving assistance processing unit 702 executes the processing in the server related to the driving assistance function (for example, an ADAS function) such as the self-driving function and the home parking function of the vehicle 1. The driving assistance function is a function including processing involving the wireless communication of the vehicle 1. The driving assistance function is an example of a function related to the safety and security of the vehicle 1.

The driver monitor processing unit 703 executes the processing in the server related to a driver monitor function of monitoring the driving posture, an eye line, a face direction, an opening/closing state of an eyelid, and the like of the driver of the vehicle 1. The driver monitor function is a function including processing involving wireless communication of the vehicle 1. The driver monitor function is an example of a function related to safety and security of the vehicle 1.

The vehicle log processing unit 704 executes the processing in the server related to a vehicle log function for collecting logs of the vehicle 1 and analyzing the collected logs. The vehicle log function is a function including processing involving wireless communication of the vehicle 1. The vehicle log function is an example of another function related to the safety and security of the vehicle 1.

The vehicle entertainment processing unit 705 executes the processing in the server related to a vehicle entertainment function that provides the user with entertainment in the vehicle 1, such as music reproduction, moving image reproduction, and smartphone cooperation of the vehicle 1. The vehicle entertainment function is a function including processing involving wireless communication of the vehicle 1. The vehicle entertainment function is an example of another function related to the safety and security of the vehicle 1.

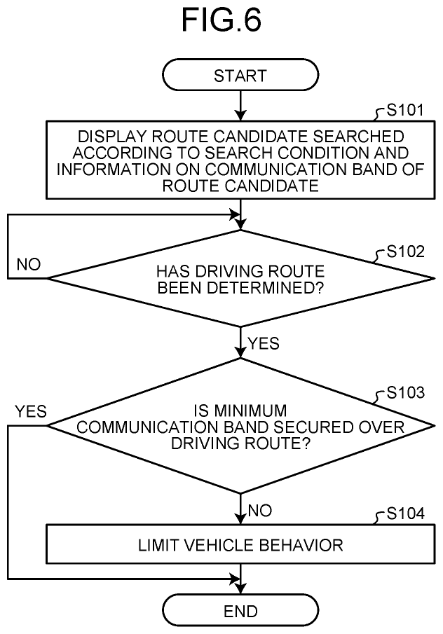

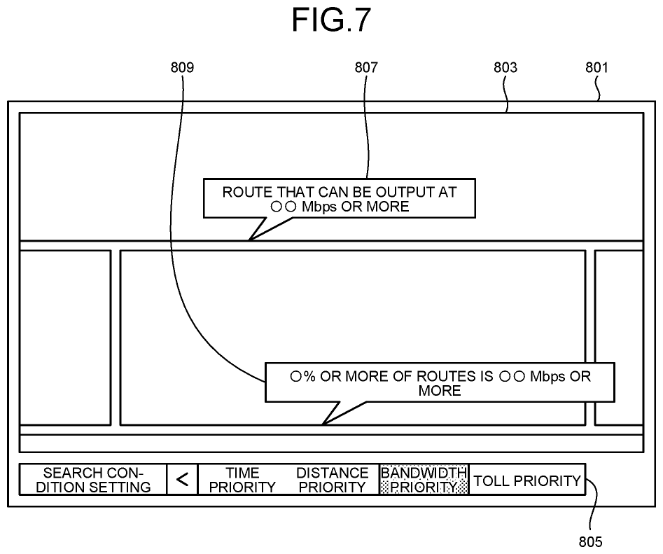

Next, a procedure of processing executed by the information processing system 9 configured as described above will be described. FIG. 6 is a flowchart illustrating an example of a procedure of vehicle behavior control processing before driving executed by the information processing system 9 according to the embodiment. FIG. 7 is a diagram illustrating an example of a display screen 801 displayed in the processing of FIG. 6.

The vehicle behavior control device 3 displays the route candidate searched according to the search condition and the information on the communication band of the route candidate from the HMI 22 (S101).

In one example, the display control unit 306 of the vehicle behavior control device 3 displays information about the band prediction value from the HMI 22 as information about the communication band of the searched route candidate as illustrated in FIG. 7. In the example of FIG. 7, the display screen 801 includes a road map 803 for displaying the route candidates, a display for setting or changing the search condition 805, and indications 807 and 809 of information about the band prediction value of the route candidate. In the example of FIG. 7, in response to selection of “bandwidth priority” as the search condition 805, the indication 807 indicates that the route candidate is “route that can be output at oo Mbps or more” and the indication 809 indicates that “0% or more of routes is oo Mbps or more”, as the information about the bandwidth prediction value of the route candidate.

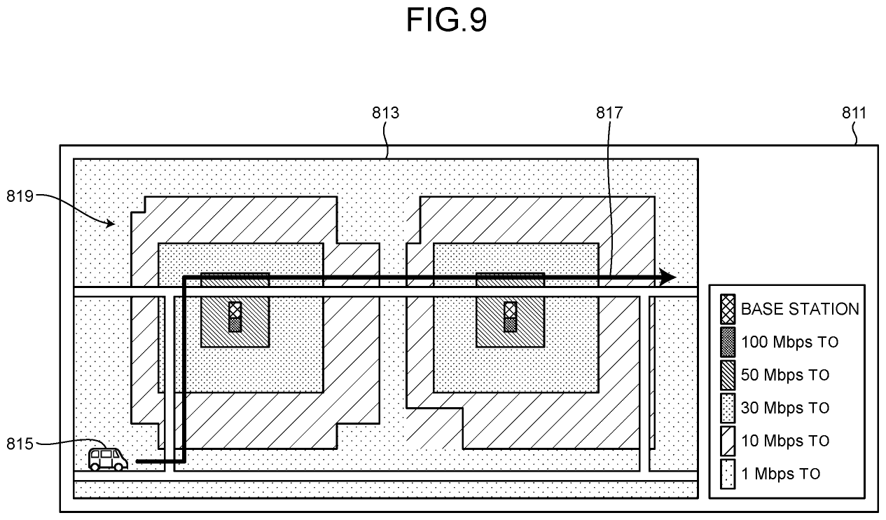

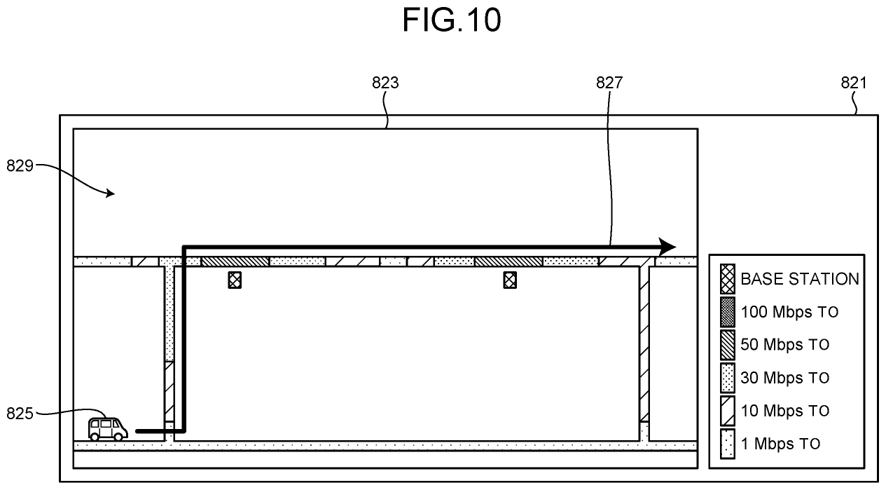

Note that FIG. 7 illustrates a case where the information about the communication band is displayed together when the route candidate is displayed, but the present disclosure is not limited thereto. The screen displaying the route candidate and the screen displaying the information on the communication band may be displayed to allow switching between them. Therefore, an operation button for selecting screen switching or display/non-display of information about the communication band may be displayed on the display screen 801. When the route candidates are displayed, it is not essential to the display information about the communication band, and there may be a mode in which normal route candidates are presented. Moreover, in a case where the “bandwidth priority” is not selected as the search condition 805, information about the communication bandwidth may be displayed. When the route candidates are displayed, a communication band map (see FIGS. 9 and 10) to be described later may be displayed as the information about the communication band.

The vehicle behavior control device 3 determines whether a driving route has been determined (S102). When the driving route has not been determined (S102: No), the procedure of FIG. 6 returns to the processing of S102. When the driving route has been determined (S102: Yes), the vehicle behavior control device 3 determines whether the minimum communication band is secured over the driving route (S103).

In one example, in a case where the information about the communication band has not been acquired when the route candidate is displayed, the communication quality determination unit 303 of the vehicle behavior control device 3 refers to the communication band map in this step, and acquires the information about the communication band of the selected route candidate, namely, estimates a band prediction value indicating a communication band predicted on the driving route.

In one example, in a case where the information about the communication band is acquired when the route candidate is displayed, the communication quality determination unit 303 of the vehicle behavior control device 3 determines whether the minimum communication band is secured over the driving route, on the basis of the band prediction value of the selected route candidate.

When the minimum communication band is secured over the driving route (S103: Yes), the procedure of FIG. 6 ends.

Meanwhile, when the minimum communication band is not secured over the driving route (S103: No), the vehicle behavior control device 3 limits the vehicle behavior (S104). Thereafter, the procedure of FIG. 6 ends.

As described above, in the information processing system 9 according to the embodiment, when searching for a route candidate that guides the vehicle 1 to the destination, it is possible to designate a search condition that gives priority to securing of a communication band at the time of driving. Specifically, when setting the driving route, the user can input a search condition that specifies which one of the time, the distance, the communication band, and the toll is prioritized to generate the driving route candidate by the HMI 22. As a result, the user can easily search for the route candidate that can obtain a stable communication band.

Moreover, in the information processing system 9 according to the embodiment, when the driving route is set, at least one of the communication band map in the driving route candidate and information about the band prediction value (information about a communication band of the route candidate) can be provided. As a result, the user can select a route for guiding the vehicle 1 with reference to the communication band obtained when driving to the destination.

In the information processing system 9 according to the embodiment, in a case where it is predicted that the minimum communication band cannot be secured over the selected route candidate, The driving route, the vehicle behavior of the vehicle 1 is limited As a result, it is possible to suppress a problem that determination as to whether self-driving is possible to the end is performed in advance, for example, before driving, and the self-driving stops on the way.

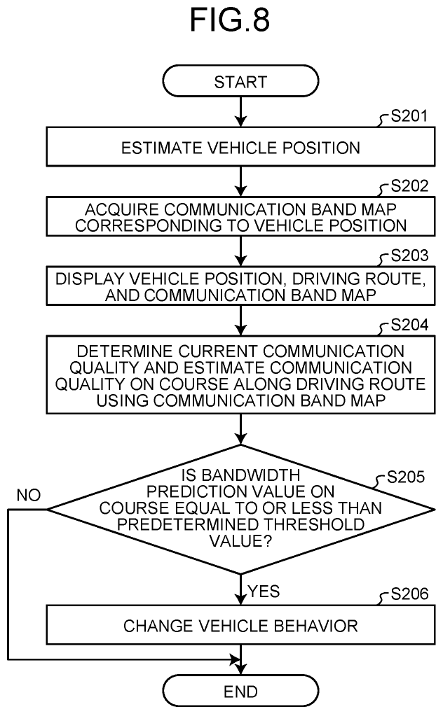

FIG. 8 is a flowchart illustrating an example of a procedure of vehicle behavior control processing during driving executed by the information processing system 9 according to the embodiment. FIG. 9 is a diagram illustrating an example of a display screen 811 displayed in the processing of FIG. 8. Here, for example, the procedure of FIG. 8 will be described by taking as an example a case where the processing is executed during the driving after the driving route is set in the procedure of FIG. 6. Note that this driving may be, for example, self-driving by the self-driving function, or may be driving by the manual driving function according to guidance of the navigation system.

The vehicle behavior control device 3 estimates the vehicle position (S201) and acquires the communication band map corresponding to the vehicle position (S202). Then, the vehicle behavior control device 3 displays the vehicle position, the driving route, and the communication band map from the HMI 22 (S203).

In one example, the display control unit 306 of the vehicle behavior control device 3 displays a communication band map 819 from the HMI 22 as information about the communication band of the driving route as illustrated in FIG. 9. In the example of FIG. 9, the display screen 811 includes a road map 813, a vehicle position 815 on the road map 813, a driving route 817 on the road map 813, and a communication band map 819. In the example of FIG. 9, a case where the communication band map 819 is superimposed and displayed on the road map 813 together with the vehicle position 815 and the driving route 817 is illustrated.

Note that FIG. 9 illustrates a case where the communication band map 819 is superimposed and displayed on the road map 813, but the present disclosure is not limited thereto. The screen for displaying the communication band map 819 and the screen for displaying the road map 813 may be displayed to allow switching between them. Therefore, an operation button for selecting screen switching or display/non-display of information about the communication band may be displayed on the display screen 811. In addition, when the route candidates are displayed, it is not essential to display information about the communication band, and there may be a mode in which normal route guidance is displayed. Moreover, as the information about the communication band of the driving route, information about a band prediction value that is based on the communication band map (see FIG. 7) may be displayed.

Note that the display of the communication band map is not limited to the example of the display screen 811. FIG. 10 is a diagram illustrating the display screen 811 as another example of a display screen 821 displayed in the processing of FIG. 8. In the example of FIG. 10, the display screen 821 includes a road map 823, a vehicle position 825 on the road map 823, a driving route 827 on the road map 823, and a communication band map 829. In the example of FIG. 10, a case where the communication band map 819 is superimposed and displayed at a position on the road or along the road along the driving route 827, for example, as in a case where traffic congestion information is conventionally displayed, is exemplified.

The vehicle behavior control device 3 determines the current communication quality, and estimates the communication quality on the course along the driving route using the communication band map (S204 in FIG. 8).

In one example, the communication quality determination unit 303 of the vehicle behavior control device 3 acquires the band actual measurement value of the current wireless communication with the wireless base station 5, and estimates the band prediction value as the communication quality on the basis of the band actual measurement value and the communication band of the communication band map of the vehicle position.

Note that the display of the communication band map 819 on the display screen 811 may be updated according to the estimation result of the band prediction value in this step, or the band prediction value in this step may be estimated prior to the display of the display screen 811.

Moreover, the communication quality determination unit 303 may correct the communication band map with the estimated band prediction value. At that time, the communication quality determination unit 303 may update the communication bandwidth map itself stored in the internal memory, or may store the difference as a separate file.

The vehicle behavior control device 3 determines whether the bandwidth prediction value on the course is equal to or less than a predetermined threshold value, namely, whether low communication quality is predicted on the course (S205 in FIG. 8). When the low communication quality is not predicted on the course (S205: No), the procedure of FIG. 8 ends.

Meanwhile, when low communication quality is predicted on the course (S205: Yes), the vehicle behavior control device 3 controls the vehicle behavior according to the communication quality (S206). Thereafter, the procedure of FIG. 8 ends.

The controlling of the vehicle behavior according to the band prediction value (S206) may include returning to the state before the control when the band prediction value on the course becomes larger than a predetermined threshold value (S205: No). For example, the communication quality determination unit 303 may release the stop (invalidation) of the self-driving function, release the limitation of the vehicle speed of the vehicle 1, or release the limitation of the communication band related to other functions of the functions related to security and safety.

As described above, the information processing system 9 according to the embodiment can control the vehicle behavior according to the band prediction value on the course of the vehicle 1 using the communication band map created in advance. Specifically, since the vehicle behavior is changed when low communication quality is predicted, the user can obtain a stable communication band during driving or drive safely under the obtained communication band.

The data processing device 7 executes, in the server, the vehicle behavior control processing for each of the vehicles 1 driving in the same area or passing through the same area on the set driving route. Therefore, in the information processing system 9 according to the embodiment, for example, the driving route and the vehicle speed of each vehicle 1 are controlled such that the number of vehicles 1 in an area where congestion of the communication band is expected is limited. FIG. 11 is a diagram for describing an example of control of a vehicle behavior in the processing of FIG. 8. As illustrated in FIG. 11, the information processing system 9 guides a large number of vehicles 1 to a driving route 851 passing through an area corresponding to a high band prediction value by controlling the driving route and the vehicle speed of each vehicle 1, and limits the number of vehicles 1 driving on a driving route 853 passing through an area corresponding to a low band prediction value. As a result, congestion in the communication band on the driving route 853 can be suppressed, and safe and secure driving of each of the vehicles 1 can be supported. Each of the vehicles 1 can obtain safe and secure driving by controlling the vehicle behavior according to the vehicle behavior control processing on the server. The number of vehicles 1 allowed in the same area may be determined according to the band prediction value of the area.

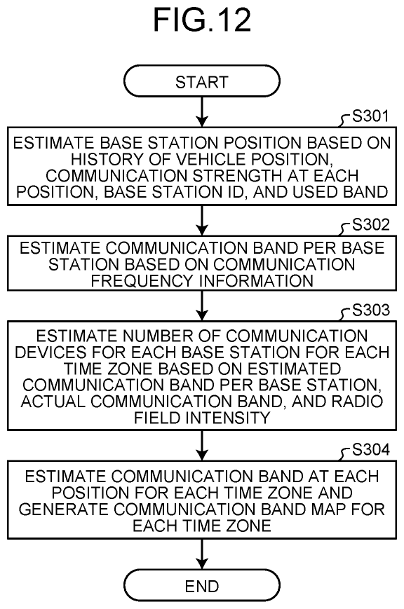

Here, generation of the communication band map according to the embodiment will be described. FIG. 12 is a flowchart illustrating an example of a procedure of the communication band map generation processing executed by the information processing system 9 according to the embodiment.

The vehicle behavior control device 3 estimates the base station position on the basis of the history of the vehicle position, The moving route, the communication strength at each position, the base station ID, and the used band (used frequency band) (S301).

In one example, the vehicle behavior control device 3 estimates a vehicle position in the driving vehicle 1 for each time zone, and acquires a moving route of the vehicle 1. The vehicle behavior control device 3 performs wireless communication for transmitting and receiving constant packets to and from the wireless base station 5 at predetermined constant intervals in the driving vehicle 1 for each time zone, and acquires the communication strength and the base station ID of the wireless communication at each position. The vehicle behavior control device 3 acquires the use band indicating the wave number band used in the wireless communication, for example, by reading the setting of the communication mode. Here, it is an example of base station information for uniquely identifying the wireless base station 5 of the base station ID communication destination.

Note that the base station position is not limited to the case of being estimated by the vehicle behavior control device 3, and may be registered in advance and stored in an internal memory, or may be acquired from the outside such as the data processing device 7.

The vehicle behavior control device 3 estimates a base station bandwidth indicating a bandwidth of a communication band per base station on the basis of the communication frequency information (S302 in FIG. 12).

The communication frequency information is information indicating a bandwidth of a communication band defined for each use band of wireless communication with the wireless base station 5, namely, a frequency range occupied by a transmission channel of the use band. The communication frequency information may be registered in advance and stored in an internal memory or the like, or may be acquired from the outside such as the data processing device 7.

The vehicle behavior control device 3 estimates the number of communication devices (the number of accommodated devices) for each base station for each time zone on the basis of the estimated base station bandwidth, the actual communication band, and the radio field intensity (S303).

In one example, the vehicle behavior control device 3 acquires an actual communication band of wireless communication with the wireless base station 5, namely, a band actual measurement value on the basis of a time required for transmission and reception of a constant packet in wireless communication in which the constant packet is transmitted and received at a predetermined constant interval.

Note that the number of accommodated base stations for each time zone is not limited to the case of being estimated by the vehicle behavior control device 3, and may be registered in advance and stored in the internal memory, or may be acquired from the outside such as the data processing device 7.

Then, the vehicle behavior control device 3 estimates a communication band at each position for each time zone on the basis of the number of accommodated base stations for each time zone and the base station bandwidth, and generates a communication band map for each time zone (S304).

Note that the procedure of FIG. 12 may be implemented as communication band map update processing of updating the generated communication band map, for example, executed together with the procedure of FIG. 8 described above.

Moreover, the procedure of FIG. 12 may be implemented as simpler processing. For example, the vehicle behavior control device 3 acquires the position and the band actual measurement value of the vehicle 1 in the same manner as described above by performing wireless communication with the wireless base station 5 in the driving vehicle 1. Then, the vehicle behavior control device 3 generates the communication band map in which the acquired band actual measurement values at the respective positions are plotted. Note that this communication band map generation processing may be implemented as processing of updating the communication band map generated in the procedure of FIG. 12. Similarly, the communication band map generated by the communication band map generation processing may be updated in the procedure of FIG. 12.

As described above, in the information processing system 9 according to the embodiment, the communication band map is generated or updated for each time zone using at least the band actual measurement value. As a result, even in a communication method in which a usable communication band greatly changes depending on an area, such as wireless communication using a millimeter wave band having strong directivity such as 5G or 6G, safe and comfortable driving can be performed by vehicle behavior control using the communication band map. Moreover, the communication band is not limited to the directivity of wireless communication, and greatly changes with the congestion state of communication, the date and time, and the weather. However, safe and comfortable driving is possible by vehicle behavior control using the communication band map generated or updated for each time zone.

Note that, in the above-described embodiment, the information processing system 9 that generates, updates, or uses the communication band map for each time zone has been described. The communication band map for each time zone may be a communication band map for each of sections in a case where one day is divided into the sections, or may be a common communication band map for two or more sections. For example, there may be an aspect in which a communication band map at a normal time and a communication band map of a specific time zone such as a commuting time zone are set. Moreover, the communication band map is not limited to a section obtained by dividing one day, and may be set for each time zone such as a day of the week and a month. In this case, a communication band map of a specific time zone such as the end of the month can be set. Moreover, the communication band map may be set for each weather instead of or in addition to the time zone. For example, as the communication band map, communication band maps may be set for each weather in one time zone.

Note that the vehicle behavior control processing and the communication band map generation processing according to the above-described embodiment may be performed in different vehicles 1. The vehicle behavior control processing according to the embodiment may use a communication band map generated in a user's vehicle or may use a communication band map generated in another vehicle. The data processing device 7 according to the embodiment may combine the communication band maps generated in the vehicles 1. This combination may be integration of communication band maps having different areas, time zones, and communication methods, or may be integration of communication band maps having the same at least some areas, time zones, and communication methods by statistical processing, for example, taking an average value or a median value.

Part of or all the processing, in the client, the vehicle behavior control processing and the communication band map generation processing by the vehicle behavior control device 3 according to the above-described embodiment may be executed outside the vehicle 1 such as the data processing device 7. For example, the vehicle behavior control processing and the communication band map generation processing using the communication band map described above may be executed outside the vehicle 1 such as the data processing device 7 such that the communication band map is held on the low-latency cloud server 6. Similarly, part of or all the processing by the data processing device 7 according to the above-described embodiment may be executed inside the vehicle 1 such as the vehicle behavior control device 3. Alternatively, the vehicle behavior control device 3 and the data processing device 7 according to the embodiment may be integrally configured. Even with these configurations, the same effects as those of the above-described embodiment can be obtained.

Note that, in each of the above-described embodiments, “determining whether it is A” may be determining that it is A, may be determining that it is not A, or may be determining whether it is A or not.

Each program executed by each device of the information processing system 9 according to each of the above-described embodiments is provided by being recorded in a computer-readable storage medium such as a CD-ROM, an FD, a CD-R, or a DVD as a file in an installable format or an executable format.

Moreover, each program executed by each device of the information processing system 9 according to each of the above-described embodiments may be stored on a computer connected to a network such as the Internet and provided by being downloaded via the network. Moreover, each program executed by each device of the information processing system 9 according to each of the above-described embodiments may be provided or distributed via a network such as the Internet.

Moreover, each program executed by each device of the information processing system 9 according to each of the above-described embodiments may be provided by being incorporated in a ROM or the like in advance.

Moreover, the program executed by each device of the information processing system 9 according to each embodiment described above has a module configuration including each functional unit described above, and as actual hardware, the CPU 41 reads and executes the program from the ROM 42 or the HDD 44, whereby each functional unit described above is loaded onto the RAM 43, and each functional unit described above is generated on the RAM 43.

According to at least one embodiment described above, it is possible to improve safety during driving of a vehicle equipped with a driving function accompanied by wireless communication.

While certain embodiments have been described, these embodiments have been presented by way of example only, and are not intended to limit the scope of the disclosures. Indeed, the novel methods and systems described herein may be embodied in a variety of other forms; moreover, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

### SUPPLEMENTARY NOTE

The description of the embodiment described above discloses the technique described below.

### Supplementary Note 1

An information processing method comprising:
acquiring a communication band map indicating a communication band of wireless communication with one of base stations;
estimating a position of a vehicle performing wireless communication with the one of base stations;
estimating a band prediction value indicating a communication band predicted for wireless communication to be performed with the one of base stations, the band prediction value being estimated on the basis of the position of the vehicle and the communication band map; and
controlling a vehicle behavior of the vehicle according to the band prediction value.

### Supplementary Note 2

The information processing method according to the supplementary note 1, further comprising:
acquiring a band actual measurement value indicating a current communication band in wireless communication between the one of base stations and the vehicle; and
estimating a band prediction value by correcting the communication band map on the basis of the position of the vehicle and the band actual measurement value.

### Supplementary Note 3

The information processing method according to the supplementary note 1 or 2, wherein the controlling of the vehicle behavior according to the band prediction value includes, when there is an area in which congestion of a communication band is predicted on the basis of the band prediction value, changing or guiding at least either one of a driving route and a vehicle speed of the vehicle such that the number of vehicles in the area is limited.

### Supplementary Note 4

The information processing method according to any one of the supplementary notes 1 to 3, wherein the controlling of the vehicle behavior according to the band prediction value includes, when the band prediction value is predicted to be equal to or less than a predetermined threshold value, changing or guiding a driving zone of the vehicle to a driving zone corresponding to a higher band prediction value.

### Supplementary Note 5

The information processing method according to any one of the supplementary notes 1 to 4, wherein the controlling of the vehicle behavior according to the band prediction value includes, when the band prediction value is predicted to be equal to or less than a predetermined threshold value, giving priority to a function related to predetermined driving and limiting a communication band related to other functions in wireless communication with the one of base stations.

### Supplementary Note 6

The information processing method according to the supplementary note 5, wherein the controlling of the vehicle behavior according to the band prediction value includes, when the band prediction value becomes larger than a predetermined threshold value, releasing the limitation of the communication band related to the other functions.

### Supplementary Note 7

The information processing method according to any one of the supplementary notes 1 to 6, wherein the controlling of the vehicle behavior according to the band prediction value includes, when the band prediction value is predicted to be equal to or less than a predetermined threshold value, changing a communication mode of wireless communication with the one of base stations.

### Supplementary Note 8

The information processing method according to any one of the supplementary notes 1 to 7, further comprising setting a driving route of the vehicle on the basis of an input of a user, wherein the controlling of the vehicle behavior according to the band prediction value includes determining in advance whether an self-driving function is executable over the entire driving route, the determining being performed on the basis of whether the band prediction value is higher than a predetermined threshold value required for wireless communication with the one of base stations related to the self-driving function over the entire set driving route.

### Supplementary Note 9

The information processing method according to any one of the supplementary notes 1 to 8, further comprising setting a driving route of the vehicle on the basis of an input of a user, wherein the controlling of the vehicle behavior according to the band prediction value includes, when the band prediction value is predicted to be equal to or less than a predetermined threshold value in at least part of the driving route, executing in advance one of stop of an self-driving function, change of a communication mode of wireless communication with the one of base stations, limitation of a vehicle speed of the vehicle, and notification to the user.

### Supplementary Note 10

The information processing method according to the supplementary note 9, wherein the setting of the driving route includes displaying either the communication band map of driving route candidates or information on the band prediction value.

### Supplementary Note 11

The information processing method according to the supplementary note 9 or 10, wherein the setting of the driving route includes receiving, from the user, an input of a search condition specifying which one of a time, a distance, a communication band, and a toll is to be prioritized to generate a driving route candidate.

### Supplementary Note 12

The information processing method according to any one of the supplementary notes 1 to 11, further comprising:
wirelessly communicating with the one of base stations while moving the vehicle;
estimating a base station bandwidth indicating a bandwidth of a communication band per base station of a communication destination, the estimating being performed on the basis of communication frequency information indicating a bandwidth of a use frequency band of wireless communication with the base station of the communication destination among the base stations; and
generating or updating the communication band map on the basis of the base station bandwidth and the number of communication performed by the base station of the communication destination for each time zone.

### Supplementary Note 13

The information processing method according to the supplementary note 12, further comprising estimating the number of communication on the basis of a band actual measurement value and radio field intensity indicating a current communication band in wireless communication with the base station of the communication destination, a position of the base station of the communication destination, and the base station bandwidth.

### Supplementary Note 14

The information processing method according to the supplementary note 13, further comprising estimating the position of the base station of the communication destination on the basis of base station information for uniquely identifying the base station of the communication destination, the used frequency band, and the radio field intensity acquired in wireless communication between a moving route of the vehicle and the base station of the communication destination.

### Supplementary Note 15

The information processing method according to any one of the supplementary notes 1 to 14, further comprising:
wirelessly communicating with the one of base stations while moving the vehicle;
acquiring a band actual measurement value indicating a current communication band in wireless communication between the one of base stations and the vehicle; and
generating or updating the communication band map on the basis of the position of the vehicle and the band actual measurement value.

### Supplementary Note 16

A computer program causing a computer to execute the information processing method according to any one of the supplementary notes 1 to 15.

### Supplementary note 17

A computer program product comprising a non-transitory computer-readable recording medium on which a computer program according to the supplementary note 16 is recorded.

What is claimed is:

1. An information processing method comprising:
acquiring a communication band map indicating a communication band of wireless communication with one of base stations;
estimating a position of a vehicle performing wireless communication with the one of base stations;
estimating a band prediction value indicating a communication band predicted for wireless communication to be performed with the one of base stations, the band prediction value being estimated on the basis of the position of the vehicle and the communication band map; and
controlling a vehicle behavior of the vehicle according to the band prediction value.

2. The information processing method according to claim 1, further comprising:
acquiring a band actual measurement value indicating a current communication band in wireless communication between the one of base stations and the vehicle; and
estimating a band prediction value by correcting the communication band map on the basis of the position of the vehicle and the band actual measurement value.

3. The information processing method according to claim 1, wherein the controlling of the vehicle behavior according to the band prediction value includes, when there is an area in which congestion of a communication band is predicted on the basis of the band prediction value, changing or guiding at least either one of a driving route and a vehicle speed of the vehicle such that the number of vehicles in the area is limited.

4. The information processing method according to claim 1, wherein the controlling of the vehicle behavior according to the band prediction value includes, when the band prediction value is predicted to be equal to or less than a predetermined threshold value, changing or guiding a driving zone of the vehicle to a driving zone corresponding to a higher band prediction value.

5. The information processing method according to claim 1, wherein the controlling of the vehicle behavior according to the band prediction value includes, when the band prediction value is predicted to be equal to or less than a predetermined threshold value, giving priority to a function related to predetermined driving and limiting a communication band related to other functions in wireless communication with the one of base stations.

6. The information processing method according to claim 5, wherein the controlling of the vehicle behavior according to the band prediction value includes, when the band prediction value becomes larger than a predetermined threshold value, releasing the limitation of the communication band related to the other functions.

7. The information processing method according to claim 1, wherein the controlling of the vehicle behavior according to the band prediction value includes, when the band prediction value is predicted to be equal to or less than a predetermined threshold value, changing a communication mode of wireless communication with the one of base stations.

8. The information processing method according to claim 1, further comprising setting a driving route of the vehicle on the basis of an input of a user,
wherein the controlling of the vehicle behavior according to the band prediction value includes determining in advance whether an self-driving function is executable over the entire driving route, the determining being performed on the basis of whether the band prediction value is higher than a predetermined threshold value required for wireless communication with the one of base stations related to the self-driving function over the entire set driving route.

9. The information processing method according to claim 1, further comprising setting a driving route of the vehicle on the basis of an input of a user,
wherein the controlling of the vehicle behavior according to the band prediction value includes, when the band prediction value is predicted to be equal to or less than a predetermined threshold value in at least part of the driving route, executing in advance one of stop of an self-driving function, change of a communication mode of wireless communication with the one of base stations, limitation of a vehicle speed of the vehicle, and notification to the user.

10. The information processing method according to claim 9, wherein the setting of the driving route includes displaying either the communication band map of driving route candidates or information on the band prediction value.

11. The information processing method according to claim 9, wherein the setting of the driving route includes receiving, from the user, an input of a search condition specifying which one of a time, a distance, a communication band, and a toll is to be prioritized to generate a driving route candidate.

12. The information processing method according to claim 1, further comprising:
wirelessly communicating with the one of base stations while moving the vehicle;
estimating a base station bandwidth indicating a bandwidth of a communication band per base station of a communication destination, the estimating being performed on the basis of communication frequency information indicating a bandwidth of a use frequency band of wireless communication with the base station of the communication destination among the base stations; and
generating or updating the communication band map on the basis of the base station bandwidth and the number of communication performed by the base station of the communication destination for each time zone.

13. The information processing method according to claim 12, further comprising estimating the number of communication on the basis of a band actual measurement value and radio field intensity indicating a current communication band in wireless communication with the base station of the communication destination, a position of the base station of the communication destination, and the base station bandwidth.

14. The information processing method according to claim 13, further comprising estimating the position of the base station of the communication destination on the basis of base station information for uniquely identifying the base station of the communication destination, the used frequency band, and the radio field intensity acquired in wireless communication between a moving route of the vehicle and the base station of the communication destination.

15. The information processing method according to claim 1, further comprising:
wirelessly communicating with the one of base stations while moving the vehicle;
acquiring a band actual measurement value indicating a current communication band in wireless communication between the one of base stations and the vehicle; and
generating or updating the communication band map on the basis of the position of the vehicle and the band actual measurement value.
